(19) United States
(12) Patent Application Publication
(10) Pub. No.: US 2009/0098043 A1
(43) Pub. Date: Apr. 16, 2009

(54) METHOD FOR PREPARING ZINC OXIDE NANOSTRUCTURES AND ZINC OXIDE NANOSTRUCTURES PREPARED BY THE SAME

(75) Inventors: Byong Gwon SONG, Seoul (KR); Seung Nam CHA, Seoul (KR); Jae Eun JUNG, Seoul (KR); Jae Eun JANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/053,888

(22) Filed: Mar. 24, 2008

(30) Foreign Application Priority Data
Oct. 12, 2007 (KR) 10-2007-0102954

(51) Int. Cl. C01G 9/02; B05D 1/18

(52) U.S. Cl. 423/622; 427/430.1; 427/443.2; 427/419.3

(57) ABSTRACT

Example embodiments provide a method for preparing zinc oxide nanostructures. According to the method, zinc oxide nanostructures are prepared by dipping a substrate having a zinc (Zn) seed layer thereon in an aqueous solution of hexamethyleneamine and dropwise adding an aqueous solution of zinc nitrate to the aqueous solution of hexamethyleneamine. In addition, zinc ions can be continuously supplied in a constant amount as the reactions of the reactants proceed to prepare high-quality zinc oxide nanostructures at a high growth rate. Furthermore, zinc oxide nanostructures can be prepared on a large-area substrate at a low processing temperature regardless of the substrate material. Example embodiments also provide zinc oxide nanostructures prepared by the method.

### PRIORITY STATEMENT

This application claims priority under U.S.C. § 119 to Korean Patent Application No. 10-2007-102954, filed on Oct. 15, 2007 in the Korean Intellectual Property Office (KIPO), the entire contents of which are incorporated herein by reference.

### BACKGROUND

1. Field

Example embodiments relate to a method for preparing zinc oxide nanostructures and zinc oxide nanostructures prepared by the method. Other example embodiments relate to a method for preparing zinc oxide nanostructures by dipping a substrate having a zinc (Zn) seed layer thereon in an aqueous solution of hexamethyleneamine and dropwise adding an aqueous solution of zinc nitrate to the aqueous solution of hexamethyleneamine to continuously supply zinc ions to the Zn seed layer.

2. Description of the Related Art

Zinc oxide (ZnO), a Group II-IV metal oxide, is a semiconductor material that has a hexagonal wurtzite crystal structure and an optical bandgap as wide as about 3.3 eV. Zinc oxide has a high transmittance and a high refractive index in the visible region and exhibits strong piezoelectric properties. Thus, the optical properties of ZnO are comparable to those of GaN used as a material for conventional UV/blue light-emitting diodes (LEDs) and laser diodes (LDs). Particularly, ZnO is reported to have an exciton binding energy three times as high as GaN at room temperature, resulting in more efficient emission than GaN. Also, ZnO has a very low threshold energy for stimulated spontaneous emission by laser pumping. Based on these advantages, zinc oxide has been used in various applications, including photonic crystals, optical modulator waveguides, varistors, transparent electrodes for use in solar cells, surface acoustic wave filters, light-emitting devices (e.g., laser diodes), flat panel displays, field emission displays (FEDs), photodetectors, gas sensors and UV shielding films.

Although most previous uses of ZnO in electronic devices utilize a thin-film format, the use of ZnO nanorods and nanowires with a nanostructure are becoming more widespread. ZnO nanowires yield their maximum efficiency by increasing the critical current density. ZnO nanowires can be coated on a glass substrate to increase the exposed area of the glass substrate as much as possible, thus achieving maximal photocatalytic efficiency.

Zinc oxide nanostructures have been prepared by various processes, for example, chemical vapor deposition (CVD), hydrothermal growth, thermal chemical vapor deposition, metal-organic chemical vapor deposition (MOCVD), molecular beam deposition, sol-gel deposition, sputtering processes, reaction evaporation, spray pyrolysis and pulsed laser deposition. The vapor deposition processes have many problems in that zinc oxide as a raw material is vaporized at a very high processing temperature of 900° C. to 1,000° C. and zinc oxide nanostructures can be grown on sapphire substrates having the same crystal growth plane as zinc oxide, thus limiting the selection of substrate materials. According to the hydrothermal growth, a substrate having a zinc oxide thin film thereon is dipped in a mixture of an aqueous solution of zinc nitrate and an aqueous solution of hexamethylenetetramine, and then zinc oxide nanostructures are grown at about 95° C. on the zinc oxide thin film. That is, the main advantage of the hydrothermal growth is that low-temperature processing is possible. However, since zinc oxide nanostructures prepared by hydrothermal growth are short in length and have rough surface, there is a limitation in the preparation of high-quality zinc oxide nanostructures using hydrothermal growth.

### SUMMARY

Accordingly, example embodiments have been made to develop a method for preparing high-quality zinc oxide nanostructures at a high growth rate by dropwise adding an aqueous solution of zinc nitrate to continuously supply zinc ions.

Example embodiments provide zinc oxide nanostructures prepared by the method.

Example embodiments also provide a material for an electronic component comprising the zinc oxide nanostructures.

### BRIEF DESCRIPTION OF THE DRAWINGS

Example embodiments will be more clearly understood from the following detailed description taken in conjunction with the accompanying drawings. FIGS. 1 to 7 represent non-limiting, example embodiments as described herein.

FIGS. 1a, 1b and 1c illustrate a method for preparing zinc oxide nanostructures according to example embodiments;

FIG. 2 is a graph showing the variations of pH as reactions proceeded in Example 1 and Comparative Example 1;

FIG. 3 is a graph showing the variation of pH as reactions proceeded in Example 2;

FIG. 4a is a scanning electron microscopy (SEM) image of zinc oxide nanowires prepared in Example 1, and FIG. 4b is a higher magnification image of FIG. 4a;

FIG. 5 is a SEM image of zinc oxide nanowires prepared in Example 2;

FIG. 6a is a SEM image of zinc oxide nanorods prepared in Comparative Example 1, and FIG. 6b is a higher magnification image of FIG. 6a; and

FIG. 7 is an X-ray diffraction (XRD) pattern showing the crystal growth direction of zinc oxide nanowires prepared in Example 1, as analyzed by XRD.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Hereinafter, example embodiments will be described in detail with reference to the attached drawings. Reference now should be made to the drawings, in which the same reference numerals are used throughout the different drawings to designate the same or similar components. In the drawings, the thicknesses and widths of layers are exaggerated for clarity. Example embodiments may, however, be embodied in many different forms and should not be construed as limited to the example embodiments set forth herein. Rather, these example embodiments are provided so that this disclosure will be thorough and complete, and will fully convey the scope of example embodiments to those skilled in the art.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration. at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments provide a method for preparing zinc oxide nanostructures, the method comprising the steps of: dipping a substrate having a zinc (Zn) seed layer thereon in an aqueous solution of hexamethyleneamine and heating the aqueous solution of hexamethyleneamine in a bath; and dropwise adding an aqueous solution of zinc nitrate to the aqueous solution of hexamethyleneamine.

The synthesis of one-dimensional zinc oxide nanostructures in an aqueous solution is known to be greatly affected by several specific reaction parameters, such as concentration, reaction rate, reaction time and pH of reactants.

The method of example embodiments is characterized in that zinc nitrate is added dropwise to hexamethyleneamine to control the concentration of zinc ions supplied, reaction rate, reaction time and pH with increasing reaction time, thereby achieving controlled length and improved quality of final nanostructures.

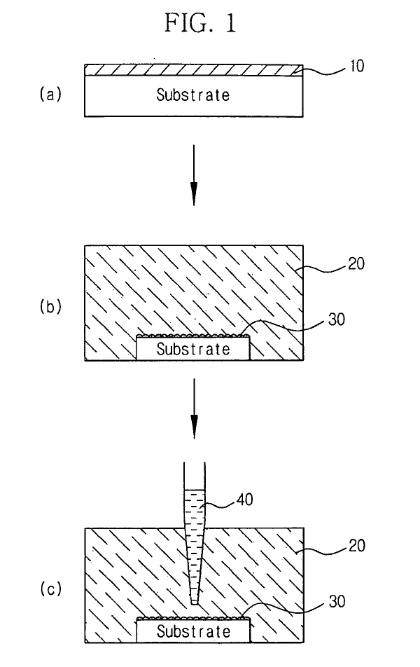

According to the method of example embodiments, a substrate is coated with zinc and is dipped in an aqueous solution of hexamethyleneamine. At this time, the zinc acts as a seed for the growth of nanostructures. FIG. 1a is a view of the substrate, on which the zinc seed layer is formed, in accordance with example embodiments. The zinc coated on the substrate serves to determine the positions where zinc oxide nanostructures are formed at the initial stage.

FIG. 1b is a view illustrating a state in which the zinc-coated substrate is dipped in the aqueous solution of hexamethyleneamine in accordance with example embodiments. The dipping allows for the formation of nuclei for the growth of zinc oxide nanostructures through a series of reactions depicted by the following Reaction Scheme 1:

### Reaction Scheme 1

(CH₂)₆N₄+6H₂O→4NH₃+6HCHO (1)

NH₃+H₂O→NH⁴⁺+OH⁻ (2)

Zn+2NH⁴⁺→Zn²⁺+2NH₃+H₂ (3)

Zn²⁺+2OH⁻→ZnO (s)+H₂O (4)

As depicted in Reaction Scheme 1, hexamethyleneamine reacts with water to form an aqueous ammonia solution (Reaction 1) and is ionized into ammonium ions and hydroxide ions (Reaction 2). Then, zinc is oxidized into zinc ions (Reaction 3). The zinc ions are reduced into zinc oxide (Reaction 4), which acts as a nucleus for the growth of zinc oxide nanostructures. Subsequently, an aqueous solution of zinc nitrate is added dropwise to the aqueous solution of hexamethyleneamine to supply zinc ions to the zinc oxide nucleus formed on the substrate, so that zinc oxide nanostructures can be continuously grown on the zinc oxide nucleus.

FIG. 1c is a view showing an instrument for the dropwise addition of the aqueous solution of zinc nitrate in accordance with example embodiments. The reaction mechanism when the aqueous solution of zinc nitrate is added dropwise to the aqueous solution of hexamethyleneamine may be depicted by Reaction 2:

### Reaction 2

C₆H₁₂N₄+8H₂O+2Zn²⁺→6HCHO+4NH⁴⁺+2ZnO (s)

The aqueous solution of zinc nitrate may be added dropwise at regular intervals of 60 to 600 seconds.

The aqueous solution of zinc nitrate may be added dropwise to any position within the aqueous solution of hexamethyleneamine. The aqueous solution of zinc nitrate is preferably added to the central portion of the substrate dipped in the aqueous solution of hexamethyleneamine.

The concentration of the aqueous solution of zinc nitrate is in the range of 0.001 to 0.1 M, but is not necessarily limited to this range. When the molar concentration of the zinc nitrate is outside the range defined above, nanoparticles may be preferentially formed rather than nanostructures.

The pH of the aqueous solution of zinc nitrate is in the range of 4.5 to 6, but is not necessarily limited to this range. When the pH of the aqueous solution of zinc nitrate is outside the range defined above, nanoparticles may be preferentially formed rather than nanostructures.

The hexamethyleneamine used in example embodiments is selected from the group consisting of, but not limited to, hexamethylenediamine, hexamethylenetriamine, hexamethylenetetramine and their mixtures.

The concentration of the aqueous solution of hexamethyleneamine is in the range of 0.001 to 0.1 M, but is not necessarily limited to this range. If the concentration of the hexamethyleneamine is outside the range defined above, nanoparticles may be preferentially formed rather than nanostructures. Even if zinc oxide nanostructures are formed, they are short in length.

The pH of the aqueous solution of hexamethyleneamine is in the range of 7 to 9, but is not necessarily limited to this range. When the pH of the aqueous solution of hexamethyleneamine is outside the range defined above, nanoparticles may be preferentially formed rather than nanostructures. Even if zinc oxide nanostructures are formed, they are short in length.

According to the method of example embodiments, hydrothermal growth is used to prepare zinc oxide nanostructures. Specifically, the aqueous solution of hexamethyleneamine, in which the substrate having the Zn seed layer thereon is dipped, is heated in a bath at atmospheric pressure and 90 to 150° C. for 120 to 600 minutes.

The zinc seed layer formed on the substrate may be oxidized to form a zinc oxide film.

The substrate may be selected from the group consisting of, but not limited to, alumina substrates, wafer substrates, ITO-coated substrates, quartz glass substrates, plastic substrates and silicon substrates.

Example embodiments provide zinc oxide nanostructures prepared by the method. There is no particular limitation on the shape of the zinc oxide nanostructures. Examples of suitable shapes for the zinc oxide nanostructures include nanorods, nanowires and nanodots.

Example embodiments also provide a material for an electronic component comprising the zinc oxide nanostructures. Such materials include, but are not necessarily limited to, materials for transparent electrodes, solar cells, photosensors, thin-film transistors (TFTs) and light-emitting devices.

Hereinafter, example embodiments will be explained in detail with reference to the following Examples and Comparative Examples. These Examples and Comparative Examples are set forth to illustrate example embodiments, but should not be construed as the limit of example embodiments.

### EXAMPLES

### Example 1

### Preparation of Zinc Oxide Nanostructures

A zinc (Zn) target was sputtered under an oxygen atmosphere to form a 20 nm-thick Zn seed layer on a silicon wafer substrate. The resulting substrate was dipped in a 0.01 M aqueous solution (pH 7.8) of hexamethylenetetramine ((CH₂)₆N₄) and heated in a bath at 90° C. for 10 minutes. 200 ml of a 0.01 M aqueous solution (pH 5.1) of zinc nitrate hexahydrate (Zn(NO₃)₂.6H₂O) was added dropwise to the central portion of the substrate using a pipette at intervals of 600 seconds over 120 minutes to prepare zinc oxide nanostructures.

### Example 2

### Preparation of Zinc Oxide Nanostructures

A zinc (Zn) target was sputtered under an oxygen atmosphere to form a 20 nm-thick Zn seed layer on a silicon wafer substrate. The resulting substrate was dipped in a 0.01 M aqueous solution (pH 8.4) of hexamethylenetetramine ((CH₂)₆N₄) and heated in a bath at 90° C. for 5 minutes. A 0.005 M aqueous solution (pH 4.8) of zinc nitrate hexahydrate (Zn(NO₃)₂.6H₂O) was added portionwise (4 ml) to the central portion of the substrate using a pipette at intervals of 600 seconds over 120 minutes to prepare zinc oxide nanostructures.

### Comparative Example 1

### Preparation of Zinc Oxide Nanostructures

Zinc oxide nanostructures were prepared in the same manner as in Example 1 except that the aqueous solution of hexamethylenetetramine ((CH₂)₆N₄) and the aqueous solution of zinc nitrate hexahydrate (Zn(NO₃)₂.6H₂O) were mixed together all at once and the substrate having the zinc seed layer thereon was dipped in the mixture without the dropwise addition of the zinc nitrate hexahydrate [Zn (NO₃)₂.6H₂O].

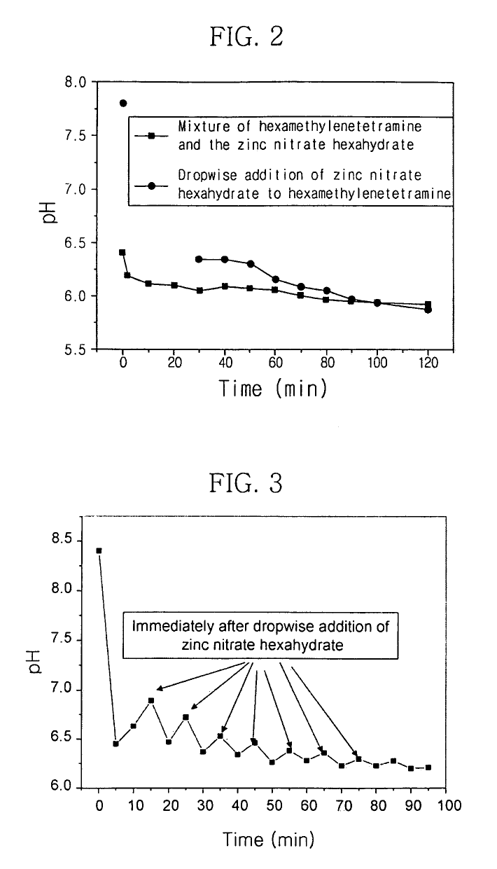

FIG. 2 is a graph showing the variations of pH as the reactions proceeded in Example 1 and Comparative Example 1. The graph shows that when the zinc nitrate hexahydrate was added dropwise to the hexamethylenetetramine to react with the substrate in Example 1, the pH of the solutions was decreased with increasing reaction time. In contrast, when the substrate was reacted with the mixture of the hexamethylenetetramine and the zinc nitrate hexahydrate in Comparative Example 1, the pH of the mixture was steeply decreased at the initial stage of the reactions. FIG. 3 is a graph showing the variation of pH as the reactions proceeded in Example 2. The graph shows that the pH of the solutions was sequentially decreased for a reaction time of 10 minutes between the successive dropwise addition of the zinc nitrate hexahydrate from immediately after the first dropwise addition of the zinc nitrate hexahydrate. The reason for the sequential decrease in pH is believed to be because the concentration of NH⁴⁺ ions, which are ionization products of the hexamethylenetetramine, was decreased and instead the amount of the final zinc oxide nanostructures was increased, as illustrated in Reaction Scheme 1.

The continuous supply of zinc ions in a constant amount for the reactions in Examples 1 and 2 offers more opportunities for the growth of zinc oxide nanostructures, whereas the supply of zinc ions in one portion for the reactions in Comparative Example 1 offers fewer opportunities for the growth of zinc oxide nanostructures. As a result, the nanostructures prepared in Examples 1 and 2 were at least 5 μm long and the nanostructures prepared in Comparative Example 1 were 2 μm or less in length for the same period of time, indicating that the growth rate of the nanostructures in Examples 1 and 2 was greater than that of the nanostructures in Comparative Example 1. This difference in growth rate is believed to be because zinc ions necessary for the reactions in Examples 1 and 2 were periodically supplied to allow zinc oxide nanostructures to be continuously grown. In contrast, since the reactions proceeded through the mixed solutions in Comparative Example 1, the amount of zinc ions supplied to the catalytic seeds was relatively small. In addition, it is believed that the difference in the concentration of zinc ions is closely connected with pH, reaction rate and reaction time, thus affecting the overall reactions.

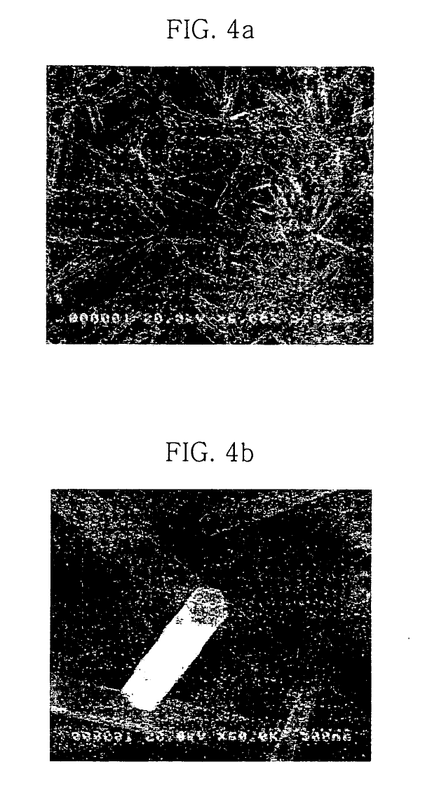

FIG. 4a is a scanning electron microscopy (SEM) image of the zinc oxide nanowires prepared in Example 1, and FIG. 4b is a higher magnification image of FIG. 4a. The images of FIGS. 4a and 4b show that the zinc oxide nanowires prepared in Example 1 were long and had a typical hexagonal structure.

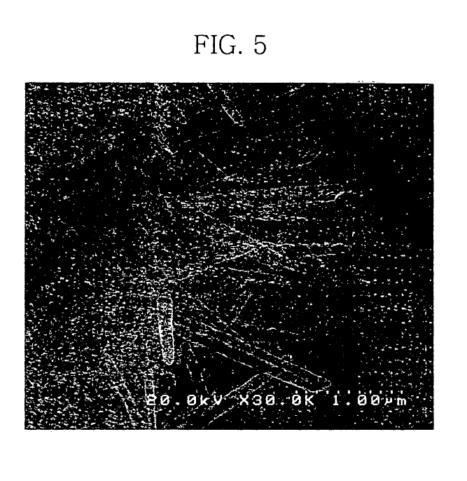

FIG. 5 is a SEM image of the zinc oxide nanowires prepared in Example 2. The image of FIG. 5 shows that the zinc oxide nanowires were long and thin.

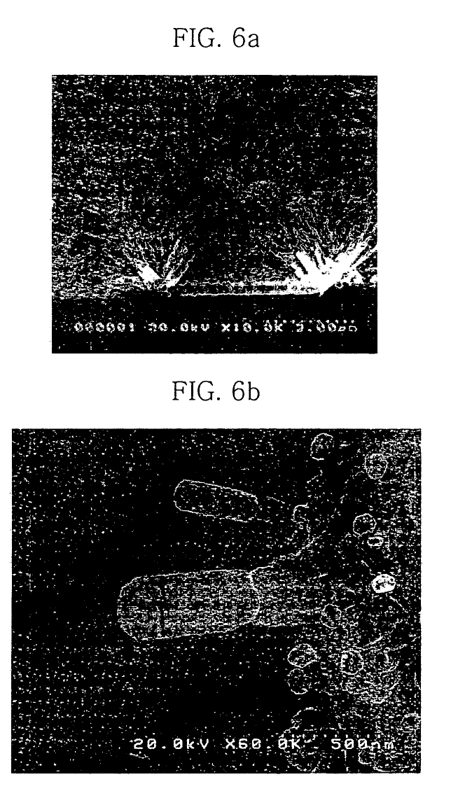

FIG. 6a is a SEM image of the zinc oxide nanorods prepared in Comparative Example 1, and FIG. 6b is a higher magnification image of FIG. 6a. The images show that the zinc oxide nanostructures prepared in Comparative Example 1 were in the form of short and thick rods with rough surfaces. No hexagonal structure was observed in the cross section of the zinc oxide nanostructures and the number of the zinc oxide nanostructures was small.

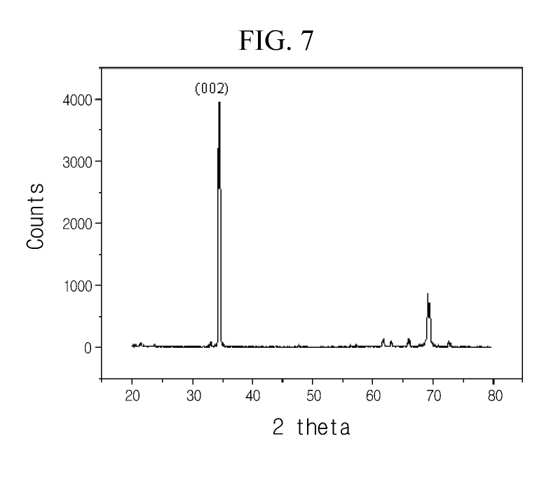

FIG. 7 is an X-ray diffraction (XRD) pattern showing the crystal growth direction of the zinc oxide nanowires prepared in Example 1, as analyzed by XRD. The pattern of FIG. 7 reveals that the crystal growth direction of the zinc oxide nanowires prepared in Example 1 coincides with a (002) orientation of typical zinc oxide nanowires.

According to the method of example embodiments, high-quality zinc oxide nanostructures can be prepared at a high growth rate because zinc ions necessary for the preparation of the nanostructures can be continuously supplied. In addition, since the method of example embodiments is a liquid-phase growth process, it can be applied to large-area substrates. Furthermore, according to the method of example embodiments, zinc oxide nanostructures can be prepared at a low processing temperature without any damage to a substrate. Therefore, the method of example embodiments can be readily applied to substrates for flexible devices and glass substrates for transparent electrodes.

Although example embodiments have been disclosed for illustrative purposes, those skilled in the art will appreciate that various modifications, additions and substitutions are possible, without departing from the scope and spirit of the accompanying claims.

What is claimed is:

1. A method for preparing zinc oxide nanostructures, the method comprising the steps of:
dipping a substrate having a zinc seed layer thereon in an aqueous solution of hexamethyleneamine and heating the aqueous solution of hexamethyleneamine in a bath; and
dropwise adding an aqueous solution of zinc nitrate to the aqueous solution of hexamethyleneamine.

2. The method according to claim 1, wherein the aqueous solution of zinc nitrate is added dropwise at intervals of 60 to 600 seconds.

3. The method according to claim 1, wherein the aqueous solution of zinc nitrate is added dropwise to the central portion of the substrate.

4. The method according to claim 1, wherein the aqueous solution of zinc nitrate has a concentration of 0.001 to 0.1 M.

5. The method according to claim 1, wherein the aqueous solution of zinc nitrate has a pH of 4.5 to 6.

6. The method according to claim 1, wherein the hexamethyleneamine is selected from the group consisting of hexamethylenediamine, hexamethylenetriamine, hexamethylenetetramine and mixtures thereof.

7. The method according to claim 1, wherein the aqueous solution of hexamethyleneamine has a concentration of 0.001 to 0.1 M.

8. The method according to claim 1, wherein the aqueous solution of hexamethyleneamine has a pH of 7 to 9.

9. The method according to claim 1, wherein hydrothermal growth is used to prepare zinc oxide nanostructures.

10. The method according to claim 9, wherein the aqueous solution of hexamethyleneamine is heated in a bath at atmospheric pressure and 90 to 150° C. for 120 to 600 minutes.

11. The method according to claim 1, wherein the zinc seed layer is oxidized to form a zinc oxide film.

12. The method according to claim 1, wherein the substrate is selected from the group consisting of alumina substrates, wafer substrates, ITO-coated substrates, quartz glass substrates, plastic substrates and silicon substrates.

13. A zinc oxide nanostructure prepared by the method according to claim 1.

14. A material for an electronic component comprising the zinc oxide nanostructure according to claim 13.

15. The material for an electronic component according to claim 14, wherein the material is used for the fabrication of an electronic component selected from transparent electrodes, solar cells, photosensors, thin-film transistors (TFTs) and light-emitting devices.
